(19) United States
(12) Patent Application Publication
(10) Pub. No.: US 2015/0356621 A1
(43) Pub. Date: Dec. 10, 2015

(54) Advertisement Management

(71) Applicant: COX COMMUNICATIONS, INC., Atlanta, GA (US)

(72) Inventors: Leslie Talansky, Atlanta, GA (US); Michael R. Zeigler, Atlanta, GA (US); Dorothy N. Buie, Atlanta, GA (US)

(21) Appl. No.: 14/298,053

(22) Filed: Jun. 6, 2014

(51) Int. Cl. G06Q 30/02

(52) U.S. Cl. CPC G06Q 30/0269; G06Q 30/0273

(57) ABSTRACT

Aspects of the disclosure relate to advertisement management that can permit, among other things, administration of delivery of advertisement assets. In one aspect, based at least on a scheduling rule, an advertisement asset associated with a promotional campaign directed to a target audience can be excluded from a delivery queue associated with a media conduit configured to convey content to the target audience. In another aspect, a second media conduit can be identified based at least on the promotional campaign in response to such exclusion. For instance, the second media conduit can be configured to convey content to an alternative audience satisfactorily similar to the target audience. In addition, if open inventory is available at the second media conduit, then the advertisement asset can be automatically scheduled in a delivery queue associated with the second media conduit. The advertisement asset so scheduled can be delivered via the second media conduit.

### BACKGROUND

Open inventory available in a media conduit, such as a television network, typically is finite and spans what usually is a small portion of the airtime and/or real-state utilized to deliver or otherwise convey content to an audience. As such, only certain advertisement assets (e.g., television spots, radio spots, or the like) can be allocated in a delivery queue for delivery of such assets within a specific open inventory, whereas the remaining advertisement assets provided or otherwise retained for delivery by an advertiser are excluded from the delivery queue or “de-queued.” Management of de-queued advertisement assets generally is laborious and highly cost ineffective, with an ensuing loss of revenue for an operator that administers one or more media conduits.

### BRIEF DESCRIPTION OF THE DRAWINGS

The accompanying drawings are an integral part of the disclosure and are incorporated into the present specification. The drawings illustrate example embodiments of the disclosure and, in conjunction with the present description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like, but not necessarily the same or identical, elements throughout.

FIG. 1 illustrates an example of advertisement management functionality in accordance with one or more aspects of the disclosure.

FIG. 2 illustrates an example of an operational environment for management of advertisements in accordance with one or more aspects of the disclosure.

FIG. 3 illustrates an example of an embodiment of a platform for management of advertisements in accordance with one or more aspects of the disclosure.

FIG. 4 illustrates an example of a computational environment for management of advertisements in accordance with one or more aspects of the disclosure.

FIG. 5 illustrates an example of a method for management of advertisements in accordance with the one or more aspects of the disclosure.

### DETAILED DESCRIPTION

The disclosure recognizes and addresses, in at least certain aspects, the issue of management of advertisement assets. More particularly, but not exclusively, the disclosure recognizes and addresses, in at least one aspect, the issue of management of advertisement assets de-queued from a delivery queue associated with media conduits intended or otherwise desired for implementation of promotional campaigns. As utilized in this disclosure, the terminology “media conduit” may refer to a platform and/or outlet the permits delivery of content to an audience via one or more architectures and/or one or more communication media. More specifically, yet not exclusively, at least one of the one or more architectures can include infrastructure that can permit generation and/or management of content (digital or otherwise), and/or transport of at least a portion of such content. The infrastructure can include one or more of server(s); camera(s) and/or audio equipment; software application(s); firmware; middleware; interface(s) (such as application programming interfaces); gateway device(s); router(s); content hub(s); data and/or signaling pipes (including wireline link(s) and/or wireless link(s), which can include satellite link(s)); combinations thereof, or the like. In addition, at least one of the one or more communication media can include digital media, printed media, wireless media (such as radio signals), combinations thereof, or the like. Accordingly, in at least certain aspects, a media conduit can include one or more of a television network, a radio station, a web-based platform, a printing facility, delivery routes for printed media, combinations thereof, or the like.

As described in greater detail below, the disclosure provides embodiments for management of advertisements that can permit, among other things, administration of delivery of advertisement assets (such as television spots, radio spots, web-based impressions, printed-media impressions, and the like) de-queued from a delivery queue associated with a media conduit intended or otherwise desired for implementation of a promotional campaign. At least some of these embodiments can automate the management of such de-queued advertisement assets, therefore mitigating or entirely removing human intervention from the administration of delivery of de-queued advertisement assets. In certain aspects of management of advertisements, the disclosure can permit exclusion of an advertisement asset associated with the promotional campaign from a delivery queue associated with a media conduit configured to convey content to a target audience. In one example, the advertisement asset can be excluded from such a delivery queue based at least on one or more scheduling rules, each of the scheduling rules configured to determined priority or lack thereof for allocation into the delivery queue. An advertisement asset that is excluded from such a delivery queue may be referred to as a de-queued advertisement asset. The disclosure also permits identification of an alternative media conduit based at least on the promotional campaign in response to such an exclusion. To at least such an end, in one example, information from various sources—such as a source of viewership information, a source of aggregated set-top box information, a source of transactional information, and/or a source of socioeconomic constitution of a group of consumers—can be acquired or otherwise accessed and processed in order to determine the second media conduit. For instance, the second media conduit can be determined based on its suitability to convey content to an alternative audience that is satisfactorily similar (e.g., identical or nearly-identical) to the target audience. In one aspect, the acquired or otherwise accessed information can be leveraged or otherwise utilized to determine the alternative audience and the second media conduit that may reach it. In one example, the alternative audience and/or the second media conduit can be determined automatically. Further to identification of such a second media conduit, the disclosure permits assessing if open inventory is available at the second media conduit, and in response to ascertaining that open inventory is available, the de-queued advertisement asset can be automatically scheduled in a second delivery queue associated with the second media conduit. The de-queued advertisement asset that is scheduled in the second delivery queue can be delivered via the second media conduit.

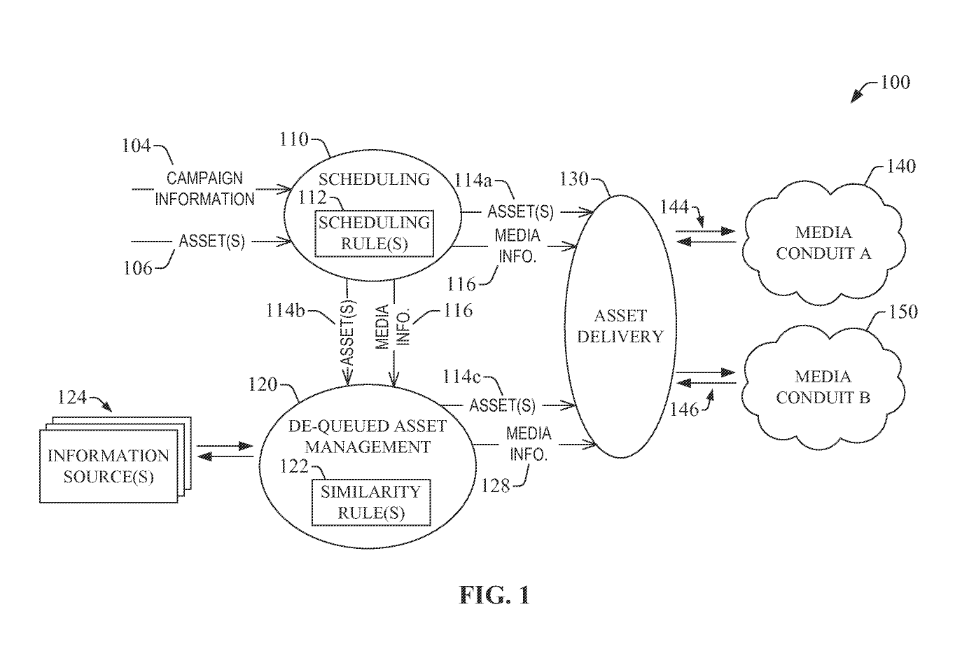

With reference to the drawings, FIG. 1 illustrates an example of the advertisement management functionality in accordance with one or more aspects of the disclosure. Promotional campaign information 104 (which herein also may be referred to as campaign information 104) and/or one or more advertisement assets 106 (also referred to as asset(s) 106) can be received at a scheduling stage 110 (also referred to as a “scheduling solution”) in which each of the asset(s) 106 can be evaluated and either allocated to a delivery queue associated with a media conduit (e.g., a television network, a radio station or network, a printed media outlet, a web-based platform, or the like) or excluded from such a delivery queue. In one example, at least one asset of the asset(s) 106 can include respective media (e.g., still images, motion pictures, an audio segment, a combination thereof, or the like) and/or a respective incentive (such as a buy-one-get-one offer, coupons or other discounts, combinations thereof, or the like). Allocation or exclusion of an advertisement asset to the delivery queue can be based at least on one or more scheduling rules 112 (referred to as scheduling rule(s) 112). The scheduling rule(s) 112 may be configured to determine priority or lack thereof for allocation into the delivery queue, and can be applied with restriction to or can contemplate a specific open inventory associated with an intended media conduit, such as media conduit A 140. As described herein, in at least certain aspects, the media conduit A 140 can include one or more of a television network, a radio station, a web-based platform, a printing facility, delivery routes for printed media, combinations thereof, or the like. As an example, an advertisement asset can be assigned a priority (or a score representative or otherwise indicative thereof) for allocation within the delivery queue, where the priority can be determined according to the revenue that may be provided by delivering or otherwise conveying the advertisement asset via an intended media conduit. Advertisement asset(s) having a sufficiently high priority can be allocated to the delivery queue, whereas other advertisement asset(s) can be excluded from the delivery queue associated with the intended media conduit (e.g., media conduit A 140).

In addition, an advertisement asset of the asset(s) 106 can be de-queued from delivery via an intended media conduit, e.g., media conduit A 140, based at least in response to a condition of the intended media conduit and/or a condition of the advertisement asset. For example, the intended media conduit or a portion thereof may not be operational at a scheduled delivery time of the advertisement asset. As such, the advertisement asset may be de-queued in response to the non-operational condition of the intended media conduit or the portion thereof. For another example, in a scenario in which the advertisement asset is embodied in or comprises a television spot or a radio spot, a change in programming schedule can result in the advertisement being de-queued. Such a change can be contemplated as a condition of the intended media conduit. More generally, a change in open inventory and/or a change in availability for delivery of the advertisement asset can result in such an asset being de-queued. For yet another example, in a scenario in which advertisement copy or specific media (e.g., still pictures, motion pictures, sounds, combinations thereof, or the like) is unavailable for an advertisement asset prior to or at a time of delivery, the advertisement asset can be de-queued.

The scheduling stage 110 can provide (e.g., identify, communicate, identify and communicate, and the like) a first group of one or more advertisement assets 114a (also referred to as asset(s) 114a) to an asset delivery stage 130. The scheduling stage 110 also can provide media information 116 that can include information indicative or otherwise representative of an intended media conduit (e.g., media conduit A 140) for delivery of at least one of the asset(s) 114a and/or an intended audience (also referred to as a “target audience”). For instance, the target audience can be directed to or otherwise embodied in male adults of ages ranging from 35-45 residing in a large metropolitan area of the United States of America, having an income ranging from $95,000 to $125,000, married and with children. In one example, each of the asset(s) 114a can be selected from the asset(s) 106 and can be included in the delivery queue associated with the intended media conduit. The asset delivery stage 130 can supply at least one of the asset(s) 114a to the intended media conduit, such as the media conduit A 140. As such, in one example, the asset delivery stage 130 can utilize or otherwise leverage infrastructure, such as components 144 (represented with arrows in FIG. 1) that can permit communication or otherwise delivery of at least a portion of one or more advertisement assets to the intended media conduit.

In addition, the scheduling stage 110 can provide a second group of one or more advertisement assets 114b (also referred to as asset(s) 114b) to a de-queued asset management stage 120. In one example, each of the asset(s) 114b can be selected from the asset(s) 106 and can be excluded from the delivery queue associated with the intended media conduit for delivery of the asset(s) 106.

The de-queued asset management stage 120 can receive the asset(s) 114b or information indicative or otherwise representative thereof. In addition or in the alternative, the de-queued asset management stage 120 can receive at least a portion of the media information 116, which can contain information indicative or otherwise representative of a respective target audience for at least one of the asset(s) 114b. Based at least on the media information 116, e.g., the information indicative of a target audience, the de-queued asset management stage 120 can identify a media conduit that can be an alternative media conduit (e.g., media conduit B 150) for delivery of one or more of the asset(s) 114b. As described herein, in at least certain aspects, the media conduit B 150 can include one or more of a television network, a radio station, a web-based platform, a printing facility, delivery routes for printed media, combinations thereof, or the like. In one example, the alternative media conduit that is identified can be configured to expose content to an alternative audience satisfactorily similar (e.g., congruent, nearly-congruent, congruent except for one metric indicative of audience constitution, or the like) to the target audience. To at least such an end, in one aspect, the de-queued management stage 120 can access (e.g., acquire or otherwise receive) information from a group of one or more information sources 124 (which may be referred to as information source(s) 124). The information source(s) 124 can include information (e.g., data and/or metadata) indicative or otherwise representative of demographics or socioeconomic constitution of one or more population segments (e.g., a consumer segment), and/or consumption or transactional behavior of a population segment. As utilized in this disclosure, “socioeconomic constitution” may refer to gender, age, ethnicity, language, income, employment status, home ownership, location, and/or other information that may be available in a census, for example. In addition, information indicative or representative of socioeconomic constitution may augment the information indicative or representative of certain demography, and depending on context, the terminology “socioeconomic constitution” and the term “demography” may be utilized interchangeably. For example, at least one of the information source(s) 124 can contain viewership information or information associated with consumption of streamed content (such as content delivered over-the-top in a web-based platform). For another example, the at least one of the information source(s) 124 can contain aggregated set-top box information, such as information associated with consumption of content (e.g., linear programming, time-shifted programming, on-demand programming, a combination thereof, or the like) via one or more set-top boxes deployed in a specific geographic region. For yet another example, at least one of the information source(s) 124 can contain census information, including household income and family composition, where such information may be location specific (e.g., specific ZIP code, specific metro area, or the like). In still another example, at least one of the information source(s) 124 can include transactional data at a merchant (e.g., such a car dealership). In addition, the de-queued asset management can apply one or more similarity rules 122 (also referred to as similarity rule(s) 122) to the accessed information in order to identify the alternative audience associated with the alternative media conduit.

In addition, the de-queued asset management stage can determine if open inventory is available for delivery of one or more advertisement assets of the asset(s) 114b via the alternative media conduit (e.g., media conduit B 150). In response to ascertaining that open inventory is available for delivery of at least one advertisement asset of the one or more advertisement assets of the asset(s) 114, the de-queued asset management stage 120 can allocate each of the at least one advertisement asset to a delivery queue associated with the alternative media conduit. The de-queued asset management stage can provide the advertisement asset(s) so allocated to the asset delivery stage 130. In certain scenarios, the de-queued asset management stage 120 can process (e.g., reformat or repackage) one or more of the allocated advertisement assets of the asset(s) 114b in order to configure such an asset or create an alternative advertisement asset for delivery via the alternative media conduit. For example, such processing can configure a television spot into a second television, a radio spot, or a web-based impression.

The de-queued asset management stage 120 also can provide media information 128 indicative or otherwise representative of the alternative media conduit (e.g., the media conduit B 150) to the asset delivery stage 130. As such, in one aspect, the asset delivery stage 130 can receive the asset(s) 114c and/or the media information 128, and can deliver at least one of the asset(s) 114c to the alternative media conduit. In one scenario, the asset delivery stage 130 can utilize or otherwise leverage infrastructure, such as components 146 (represented with arrows in FIG. 1), that can permit communication or otherwise delivery of at least a portion of one or more advertisement assets to the alternative media conduit.

It should be appreciated that, in certain scenarios, one or more advertisement assets of the asset(s) 114b may not be allocated to a delivery queue in an alternative network. The de-queued asset management stage 120 can configure at least one of such asset(s) in a holding state or can direct the at least one such asset to exception handling. It should also be appreciated that while the asset delivery stage 130 is illustrated as being functionally coupled to two media conduits (e.g., media conduit A 140 and media conduit B 150), the disclosure is not so limited and the asset delivery stage 130 can be functionally coupled to numerous media conduits.

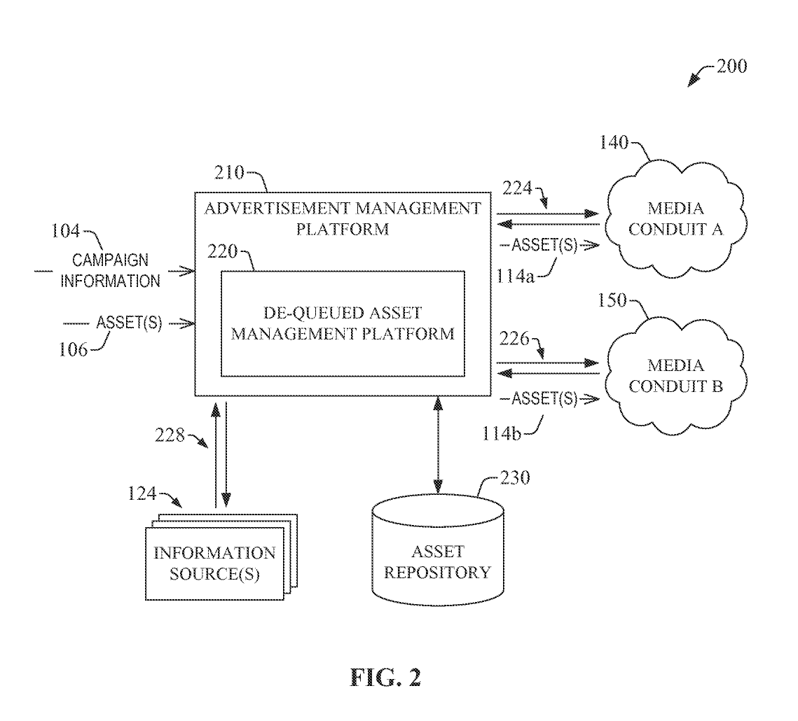

FIG. 2 illustrates an example of an operational environment 200 for management of advertisement in accordance with one or more aspects of the disclosure. The illustrated operational environment 200 can implement at least the example functionality described in connection with FIG. 1. More particularly, yet not exclusively, the operational environment 200 includes an advertisement management platform 210 that can receive the campaign information 104 and/or the asset(s) 106. In the illustrated embodiment, the advertisement management platform 210 includes a de-queued asset management platform 220 that can receive at least a portion of such information and/or asset(s), and can implement at least one of the scheduling stage 110, the de-queued asset management stage 120, or the asset delivery stage 130. In other embodiments, the advertisement management platform 210 can include a scheduler platform and/or a delivery platform (neither shown in FIG. 2), where the scheduler platform can implement the scheduling stage 110 and the delivery platform can implement the asset delivery stage 130. Accordingly, as illustrated, at least one of the information source(s) 124 can be functionally coupled (e.g., communicatively coupled) with the advertisement management platform 210 via link(s) 228. Other components and/or infrastructure also can permit such functional coupling. Similarly, the advertisement management platform 210 or a component thereof can be functionally coupled (e.g., communicatively coupled) with numerous media conduits via various infrastructure. For instance, the advertisement media platform 210 can be functionally coupled to the media conduit 140 and the media conduit B 150 via component(s) 224 and component(s) 226, respectfully. Other components and/or infrastructure also can permit such functional coupling. In addition, the advertisement management platform 210 can be functionally coupled to one or more memory devices 230 (referred to as asset repository 230) that can retain information indicative or otherwise representative of advertisement assets (e.g., de-queued assets or otherwise). Other information in accordance with aspects of this disclosure also can be retained in the asset repository 230.

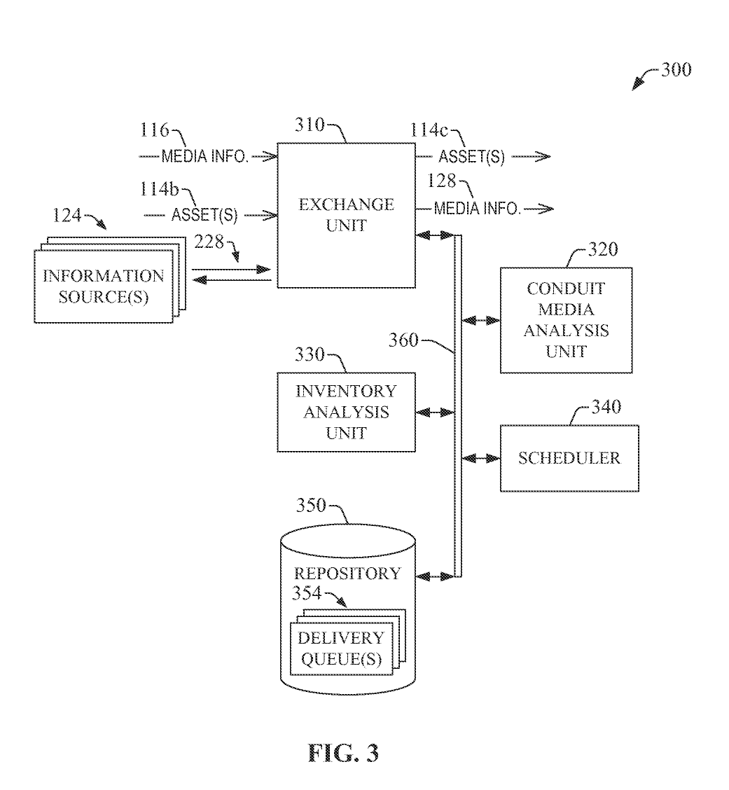

FIG. 3 illustrates an example embodiment 300 of the de-queued asset management platform 220 in accordance with one or more aspects of the disclosure. As illustrated, an exchange unit 310 can receive one or more of the media information 116, the asset(s) 114b, or information from at least one of the information source(s) 124. In the illustrated embodiments, the exchange unit 310 can receive information from at least one of the information source(s) 124 via one or more of the link(s) 228. In one aspect, the exchange unit 310 can communicate at least a portion of the received information to a conduit media analysis unit 320, which can apply one or more similarity rules to such information in order to identify a media conduit. The media conduit can be configured to convey content to an audience that is satisfactorily similar to a target audience conveyed or otherwise identified by the media information 116. As such, in one aspect, the conduit media analysis unit 320 can analyze the received information and can identify the media conduit based at least in part on the fitness (which can be measured via a score, which can be a real or natural number, or a logical value) of the media conduit to reach (or otherwise convey content to) a specific audience. In one example, the conduit media analysis unit 320 can determine such fitness via application of the one or more similarity rules. The identified media conduit may be referred to as an alternative conduit.

As described herein, in response to identifying an alternative media conduit, an inventory analysis unit 330 can ascertain that either open inventory is available at the alternative media conduit or open inventory is unavailable at the alternative media conduit. In a scenario in which it is ascertained that open inventory is available, the scheduler unit 340 (or scheduler 340) can allocate at least one of the asset(s) 114b in a delivery queue of the alternative media conduit. Information indicative or otherwise representative of delivery queues for alternative media conduits may be retained or otherwise stored in one or more memory elements 354 (represented as delivery queue(s) 354 in FIG. 3) integrated into or otherwise functionally coupled to one or more memory devices 350 (represented as repository 350 in FIG. 3). In one example, the exchange unit 310 can communicate an advertisement asset allocated as described herein and/or media information 128 that is indicative or otherwise representative of the alternative media conduit can be communicated to a delivery platform (not shown in FIG. 3).

While not illustrated in embodiment 300, in certain embodiments, the de-queued asset management platform 220 can include a composition unit that can reformat or otherwise repackage an advertisement asset from an initial format (e.g., a television spot) to an alternative format (e.g., a radio spot or a web-based impression) adequate for delivery on the alternative media conduit identified by the conduit media analysis unit 320 in accordance with aspects of this disclosure.

The functional elements illustrated in embodiment 300 can communicate (e.g., transmit, receive, or exchange information) via a communication platform 360, which can include a bus architecture, wireless link(s), wireline link(s), middleware, reference link(s), combinations thereof, or the like.

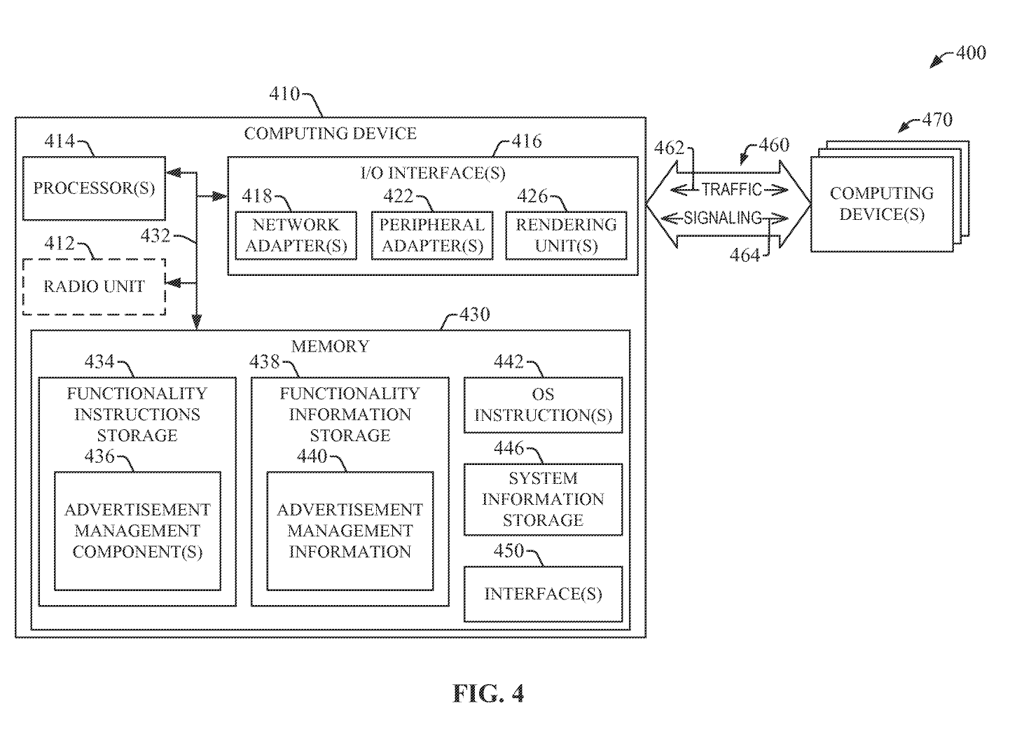

FIG. 4 illustrates a block diagram of an example computational environment 400 for management of advertisements in accordance with one or more aspects of the disclosure. The example computational environment 400 is merely illustrative and is not intended to suggest or otherwise convey any limitation as to the scope of use or functionality of the computational environment's architecture. In addition, the illustrative computational environment 400 depicted in FIG. 4 should not be interpreted as having any dependency or requirement relating to any one or combination of components illustrated in the example operational environments of the disclosure. The example computational environment 400 or portions thereof can embody or can comprise, for example, the advertisement management platform 210, the de-queued asset management platform 220, the information source(s) 124, and/or the asset repository 230.

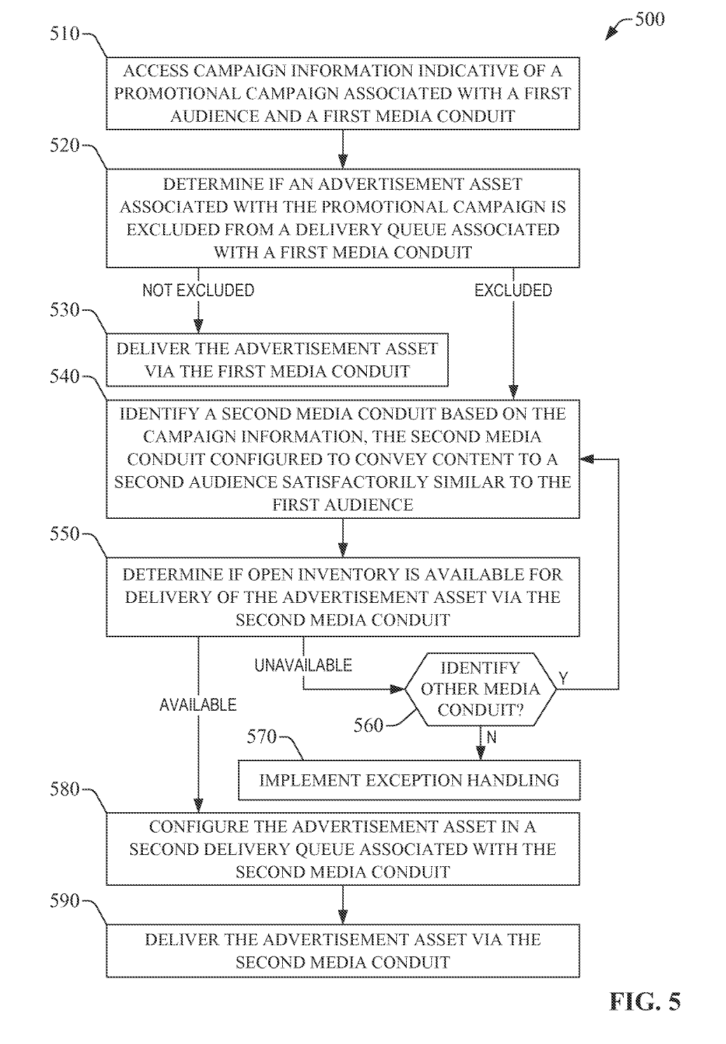

The computational environment 400 represents an example implementation of the various aspects or features of the disclosure in which the processing or execution of operations described in connection with the advertisement management disclosed herein can be performed in response to execution of one or more software components at the computing device 410. It should be appreciated that the one or more software components can render the computing device 410, or any other computing device that contains such components, a particular machine for advertisement management as described herein, among other functional purposes. A software component can be embodied in or can comprise one or more computer-accessible instructions, e.g., computer-readable and/or computer-executable instructions. In one scenario, at least a portion of the computer-accessible instructions can embody and/or can be executed to perform at least a part of one or more of the example methods described herein, such as the example methods presented in FIG. 5. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device 410 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 410 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the advertisement management described herein can comprise personal computers; server computers; laptop devices; handheld computing devices, such as mobile tablets or electronic-book readers (e-readers); wearable computing devices; and multiprocessor systems. Additional examples can include set-top boxes, programmable consumer electronics, network personal computers (PCs), minicomputers, mainframe computers, blade computers, programmable logic controllers, distributed computing environments that comprise any of the above systems or devices, and the like.

As illustrated, the computing device 410 can comprise one or more processors 414, one or more input/output (I/O) interfaces 416, a memory 430, and a bus architecture 432 (also termed bus 432) that functionally couples various functional elements of the computing device 410. In certain embodiments, the computing device 410 can include, optionally, a radio unit 412. The radio unit 412 can include one or more antennas and a communication processing unit that can permit wireless communication between the computing device 410 and another device, such as one of the computing device(s) 470. The bus 432 can include at least one of a system bus, a memory bus, an address bus, or a message bus, and can permit exchange of information (data, metadata, and/or signaling) between the processor(s) 414, the I/O interface(s) 416, and/or the memory 430, or respective functional elements therein. In certain scenarios, the bus 432 in conjunction with one or more internal programming interfaces 450 (also referred to as interface(s) 450) can permit such exchange of information. In scenarios in which the processor(s) 414 include multiple processors, the computing device 410 can utilize parallel computing.

The I/O interface(s) 416 can permit communication of information between the computing device and an external device, such as another computing device, e.g., a network element or an end-user device. Such communication can include direct communication or indirect communication, such as exchange of information between the computing device 410 and the external device via a network or elements thereof. As illustrated, the I/O interface(s) 416 can comprise one or more of network adapter(s) 418, peripheral adapter(s) 422, and rendering unit(s) 426. Such adapter(s) can permit or facilitate connectivity between the external device and one or more of the processor(s) 414 or the memory 430. For example, the peripheral adapter(s) 422 can include a group of ports, which can include at least one of parallel ports, serial ports, Ethernet ports, V.35 ports, or X.21 ports. In certain embodiments, the parallel ports can comprise General Purpose Interface Bus (GPIB), IEEE-1284, while the serial ports can include Recommended Standard (RS)-232, V.11, Universal Serial Bus (USB), FireWire or IEEE-1394.

In one aspect, at least one of the network adapter(s) 418 can functionally couple the computing device 410 to one or more computing devices 470 via one or more traffic and signaling pipes 460 that can permit or facilitate the exchange of traffic 462 and signaling 464 between the computing device 410 and the one or more computing devices 470. For example, one or more of such data and signaling pipes can embody or can constitute at least a portion of the components 144, components 146, component(s) 224, component(s) 226, and/or link(s) 228. Such network coupling provided at least in part by the at least one of the network adapter(s) 418 can be implemented in a wired environment, a wireless environment, or both. The information that is communicated by the at least one of the network adapter(s) 418 can result from the implementation of one or more operations of a method in accordance with aspects of this disclosure. Such output can be any form of visual representation, including, but not limited to, textual, graphical, animation, audio, tactile, and the like. In certain scenarios, each of the computing device(s) 470 can have substantially the same architecture as the computing device 410. In addition or in the alternative, the rendering unit(s) 426 can include functional elements (e.g., lights, such as light-emitting diodes; a display, such as a liquid crystal display (LCD), a plasma monitor, a light emitting diode (LED) monitor, or an electrochromic monitor; combinations thereof; or the like) that can permit control of the operation of the computing device 410, or can permit conveying or revealing the operational conditions of the computing device 410.

In one aspect, the bus 432 represents one or more of several possible types of bus structures, including a memory bus or a memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like. The bus 432, and all buses described herein can be implemented over a wired or wireless network connection and each of the subsystems, including the processor(s) 414, the memory 430 and memory elements therein, and the I/O interface(s) 416 can be contained within one or more remote computing devices 470 at physically separate locations, connected through buses of this form, in effect implementing a fully distributed system.

The computing device 410 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 410, and can comprise, for example, both volatile and non-volatile media, and removable and/or non-removable media. In one aspect, the memory 430 can comprise computer-readable media in the form of volatile memory, such as random access memory (RAM), and/or non-volatile memory, such as read-only memory (ROM).

The memory 430 can comprise functionality instructions storage 434 and functionality information storage 438. The functionality instructions storage 434 can comprise computer-accessible instructions that, in response to execution (by at least one of the processor(s) 414), can implement one or more of the functionalities of the disclosure. The computer-accessible instructions can embody or can comprise one or more software components illustrated as advertisement management component(s) 436. In one scenario, execution of at least one component of the advertisement management component(s) 436 can implement one or more of the methods described herein, such as example method 400. For instance, such execution can cause a processor (e.g., one of the processor(s) 414) that executes the at least one component to carry out a disclosed example method. It should be appreciated that, in one aspect, a processor of the processor(s) 414 that executes at least one of the advertisement management component(s) 436 can retrieve information from or retain information in one or more memory elements 440 in the functionality information storage 438 in order to operate in accordance with the functionality programmed or otherwise configured by the advertisement management component(s) 436. The one or more memory elements 440 may be referred to as advertisement management information 440. Such information can include at least one of code instructions, information structures, or the like. For instance, at least a portion of such information structures can be indicative or otherwise representative of a delivery queue (such as one of the delivery queue(s) 354); scheduling priority of an advertisement asset; a target audience and/or an alternative audience; a combination thereof; or the like. In certain embodiments, the functionality information storage 438 can embody or can constitute the repository 350. In other embodiments, the repository 350 can be distributed between the functionality information storage 438 and similar storage devices present in or functionally coupled to one or more of the computing device(s) 470.

In certain embodiments, one or more of the advertisement management component(s) 436 can embody or can constitute at least one of the exchange unit 310, the conduit media analysis unit 320, the inventory analysis unit 330, and/or the scheduler 340 and can provide the functionality of such units in accordance with aspects of this disclosure. In other embodiments, one or more of the advertisement management component(s) 436 in combination with at least one of the processor(s) 414 and/or at least one of the I/O interface(s) 416 can embody or can constitute at least one of the exchange unit 310, the conduit media analysis unit 320, the inventory analysis unit 330, and/or the scheduler 340, and can provide the functionality of such units in accordance with aspects of this disclosure. In other embodiments, at least one of the remote computing devices 470 can have an architecture similar to that of the computing device 410, and the exchange unit 310, the conduit media analysis unit 320, the inventory analysis unit 330, the scheduler 340, and/or the repository 350 can be implemented in a distributed fashion via the at least one of the computing devices 470 and the computing device 410. In such distributed environments, the communication platform 360 can be embodied by at least a portion of the data and signaling pipes 460.

At least one of the one or more interfaces 450 (e.g., application programming interface(s)) can permit or facilitate communication of information between two or more components within the functionality instructions storage 434. The information that is communicated by the at least one interface can result from the implementation of one or more operations in a method of the disclosure. In certain embodiments, one or more of the functionality instructions storage 434 and the functionality information storage 438 can be embodied in or can comprise removable/non-removable, and/or volatile/non-volatile computer storage media.

At least a portion of at least one of the advertisement management component(s) 436 or advertisement management information 440 can program or otherwise configure one or more of the processors 414 to operate at least in accordance with the functionality described herein. One or more of the processor(s) 414 can execute at least one of the advertisement management component(s) 436 and leverage at least a portion of the information in the functionality information storage 438 in order to provide advertisement management in accordance with one or more aspects described herein.

It should be appreciated that, in certain scenarios, the functionality instruction(s) storage 434 can embody or can comprise a computer-readable non-transitory storage medium having computer-accessible instructions that, in response to execution, cause at least one processor (e.g., one or more of the processor(s) 414) to perform a group of operations comprising the operations or blocks described in connection with the disclosed methods.

In addition, the memory 430 can comprise computer-accessible instructions and information (e.g., data, metadata, and/or programming code instructions) that permit or facilitate the operation and/or administration (e.g., upgrades, software installation, any other configuration, or the like) of the computing device 410. Accordingly, as illustrated, the memory 430 can comprise a memory element 442 (labeled operating system (OS) instruction(s) 442) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architectural complexity of the computing device 410 can dictate a suitable OS. The memory 430 also comprises a system information storage 446 having data, metadata, and/or programming code that permits or facilitates the operation and/or administration of the computing device 410. Elements of the OS instruction(s) 442 and the system information storage 446 can be accessible or can be operated on by at least one of the processor(s) 414.

It should be recognized that while the functionality instructions storage 434 and other executable program components, such as the OS instruction(s) 442, are illustrated herein as discrete blocks, such software components can reside at various times in different memory components of the computing device 410, and can be executed by at least one of the processor(s) 414. In certain scenarios, an implementation of the advertisement management component(s) 436 can be retained on or transmitted across some form of computer-readable media.

The computing device 410 and/or one of the computing device(s) 470 can include a power supply (not shown), which can power up components or functional elements within such devices. The power supply can be a rechargeable power supply, e.g., a rechargeable battery, and it can include one or more transformers to achieve a power level suitable for the operation of the computing device 410 and/or one of the computing device(s) 470, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 418) to connect operationally to the conventional power grid. In another aspect, the power supply can include an energy conversion component, such as a solar panel, to provide additional or alternative power resources or autonomy for the computing device 410 and/or one of the computing device(s) 470.

As described herein, the computing device 410 can operate in a networked environment by utilizing connections to one or more remote computing devices 470. As an illustration, a remote computing device can be a personal computer, a portable computer, a server, a router, a network computer, a peer device or other common network node, and so on. As described herein, connections (physical and/or logical) between the computing device 410 and a computing device of the one or more remote computing devices 470 can be made via one or more traffic and signaling pipes 460, which can comprise wired link(s) and/or wireless link(s) and several network elements (such as routers or switches, concentrators, servers, and the like) that form a local area network (LAN), a wide area network (WAN), and/or other networks (wireless or wired) having different footprints. Such networking environments are conventional and commonplace in dwellings, offices, enterprise-wide computer networks, intranets, local area networks, and wide area networks.

In one or more embodiments, one or more of the disclosed functionality (such as methods) can be practiced in distributed computing environments, such as grid-based environments or cloud configurations, where tasks can be performed by remote processing devices (computing device(s) 470) that are functionally coupled (e.g., communicatively linked or otherwise coupled) through a network having traffic and signaling pipes and related network elements. In a distributed computing environment, in one aspect, one or more software components (such as program modules) can be located in both a local computing device 410 and at least one remote computing device.

In addition, a group of one or more of the computing device(s) 470 and/or at least a portion of the data and signaling pipe(s) 460 can embody or can constitute a media conduit, where such a group of computing device(s) can embody or can constitute at least some of the architecture that can be present in media conduits. While not depicted in FIG. 4, at least one computing device of such a group of devices can leverage or otherwise utilize a communication medium to communicate advertisement to an end-user or an end-user device (e.g., a set-top box and/or a terminal display) associated with the end-user.

In view of the features described herein, example of techniques for advertisement management in accordance with one or more aspects of this disclosure can be better understood with reference, for example, to the flowchart in FIG. 5. For purposes of simplicity of explanation, the example methods disclosed herein are presented and described as a series of blocks (with each block representing an action or an operation in a method, for example). However, it is to be understood and appreciated that the disclosed methods are not limited by the order of blocks and associated actions or operations, as some blocks may occur in different orders and/or concurrently with other blocks from those that are shown and described herein. For example, the various methods (or processes or techniques) in accordance with this disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

It should be appreciated that the methods in accordance with this disclosure can be retained on an article of manufacture, or computer-readable medium, to permit or facilitate transporting and transferring such methods to a computing device (e.g., a desktop computer; a mobile computer, such as a tablet, or a smartphone; a gaming console; a mobile telephone; a blade computer; a programmable logic controller; and the like) for execution, and thus implementation, by a processor of the computing device or for storage in a memory thereof or functionally coupled thereto. In one aspect, one or more processors, such as processor(s) that implement (e.g., execute) one or more of the disclosed methods, can be employed to execute code instructions retained in a memory, or any computer- or machine-readable medium, to implement the one or more of the disclosed methods. The code instructions can provide a computer-executable or machine-executable framework to implement the methods described herein.

More specifically, FIG. 5 presents a flowchart of an example method for advertisement management in accordance with at least one aspect of the disclosure. A computing platform or system including one or more processors and one or more memory devices, where the one or more processors can be functionally coupled (individually or collectively) to all or a group of the one or more memory devices. As illustrated, at block 510, campaign information indicative of a promotional campaign associated with a first audience and first media conduit can be accessed or otherwise acquired. The campaign information (e.g., campaign information 104) can include information (e.g., data and/or metadata) indicative or otherwise representative of the first media conduit (e.g., media conduit A 140) and/or the first audience. The first audience can be referred to as a “target audience.” In one example, the target audience can be directed to or otherwise embodied in adults of ages ranging from 18-25 in the Midwest of the United States of America, having an income ranging from $55,000 to $75,000, single and without children).

At block 520, it can be determined if an advertisement asset (e.g., a television spot, a radio spot, a printed-media image, a digital media image (still picture or motion picture), or the like) associated with the promotional campaign is excluded from a delivery queue associated with the first media conduit. Determining if the advertisement asset associated with the promotional campaign is excluded from the delivery queue associated with a first media conduit may be implemented in several ways. In one example implementation, a priority for allocation within the delivery queue can be assigned, and the advertisement media asset can be excluded from the delivery queue in response to the priority being below a predetermined threshold. For instance, such a priority can be determined based at least on the revenue that may be provided by delivering the advertisement asset via the first media conduit. In another example implementation, a condition for exclusion of the advertisement asset from the delivery queue can be validated, where the condition can include an operational condition of the first media conduit or a condition of the advertisement asset. Validation of such a condition (e.g., a positive determination that the condition is established) can result in the advertisement asset being excluded from the delivery queue. In yet another example implementation, a group of advertisement assets including the advertisement asset can be ranked based at least on respective advertisement spend for each of the group of advertisement assets. Based at least on the ranking, a second group of advertisement assets that fits open inventory associated with the delivery queue may be determined or otherwise identified. In addition, it can be determined if the advertisement asset is included in the second group of advertisement assets, and in response to ascertaining that the advertisement asset is not included in the second group, the advertisement can be excluded from the delivery queue associated with the first media conduit.

In response to ascertaining that the advertisement asset is not excluded, such an asset can be delivered via the first media conduit at block 530. In the alternative, at block 540, in response to ascertaining that the advertisement asset is excluded from the delivery queue, a second media conduit (e.g., media conduit B 150) can be identified based at least on the campaign information (e.g., information indicative or otherwise representative of the target audience and the intended fly-time for advertisement related to the campaign). In one example, the second media conduit can be configured to convey content to a second audience satisfactorily similar to (e.g., congruent or nearly-congruent with) the first audience. The second audience can be referred to as an “alternative audience.”

At block 550, it can be determined if open inventory is available for delivery of the advertisement asset via the second media conduit. In response to ascertaining that open inventory is unavailable, at block 560, it can be determined whether a further alternative media conduit is to be identified. An affirmative determination can result in the example method being redirected to block 540. In contrast, a negative determination can result in the example method being redirected to block 570 at which exception handling can be implemented. Further, in response to ascertaining at block 550 that open inventory is available, at block 580, the advertisement asset can be configured (e.g., allocated) in a second delivery queue associated with the second media conduit. At block 590, the advertisement asset can be delivered via the second media conduit.

As described herein, in certain embodiments, an advertisement asset that is managed according to the subject example method 500 can include a television spot, and the first media conduit can include an intended or otherwise desired television network. In addition, the second media conduit can include an alternative television network. Accordingly, in a scenario in which such an advertisement asset is excluded from a delivery queue associated with the intended television network, it may be scheduled in a second delivery queue associated with the alternative television network, and it may be delivered therethrough. In other embodiments, the the second media conduit can include a web-based platform (e.g., a content delivery network, one or servers, and one or more client devices). Therefore, in one aspect, in response to the advertisement asset being de-queued, it may be scheduled in a second delivery queue associated with the web-based platform, and it may be delivered therethrough. In yet other embodiments, the second media conduit can include a radio station. As such, in one aspect, in response to the advertisement asset being de-queued, it may be scheduled in a second delivery queue associated with the web-based platform, and it may be delivered therethrough.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, etc.

Embodiments of the operational environments and methods (or techniques) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of embodiments described in the specification or annexed drawings, or the like.

As used in this application, the terms “component,” “environment,” “system,” “architecture,” “stage,” “interface,” “unit,” “module,” “pipe,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, and the electronic components can include a processor therein to execute software or firmware that provides, at least in part, the functionality of the electronic components. An interface can include input/output (I/O) components as well as associated processor, application, and/or other programming components. The terms “component,” “environment,” “system,” “architecture,” “stage,” “interface,” “unit,” “module,” and “pipe” can be utilized interchangeably and can be collectively referred to as functional elements.

As utilized in this disclosure, the term “processor” can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance the performance of user equipment or other electronic equipment.

In addition, in the present specification and annexed drawings, terms such as “store,” storage,” “data store,” “data storage,” “memory,” “repository,” and substantially any other information storage component relevant to the operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Examples of various types of non-transitory storage media can include hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of the operational or computational environments described herein are intended to include one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, and techniques that can provide advertisement management that can permit, among other things, administration of delivery of advertisement assets de-queued from a delivery queue associated with a media conduit intended or otherwise desired for implementation of a promotional campaign. It is, of course, not possible to describe every conceivable combination of elements and/or methods for purposes of describing the various features of the disclosure, but it can be recognize that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A method for advertisement management, comprising:
accessing, via at least a computing system comprising at least one processor functionally coupled to at least one memory device, campaign information indicative of a promotional campaign directed to a first audience via a first media conduit;
determining, via at least the computing system, if an advertisement asset associated with the promotional campaign is excluded from a first delivery queue associated with the first media conduit;
identifying, via at least the computing system, a second media conduit based at least on the campaign information in response to ascertaining that the advertisement asset is excluded from the first delivery queue, the second media conduit is configured to convey content to a second audience satisfactorily similar to the first audience;
determining, via at least the computing system, if open inventory is available for delivery of the advertisement asset via the second media conduit; and
configuring, via at least the computing system, the advertisement asset in a second delivery queue associated with the second media conduit in response to ascertaining that the open inventory is available.

2. The method of claim 1, further comprising delivering, via at least the computing system, the advertisement asset via the second media conduit.

3. The method of claim 1, wherein determining, via at least the computing system, if the advertisement asset associated with the promotional campaign is excluded from the delivery queue associated with a first media conduit comprises assigning a priority for allocation within the delivery queue, wherein the priority is determined according to a revenue provided by delivering the advertisement asset via the first media conduit, and excluding the advertisement media asset from the delivery queue in response to the priority being below a predetermined threshold.

4. The method of claim 1, wherein determining, via at least the computing system, if the advertisement asset associated with the promotional campaign is excluded from the delivery queue associated with a first media conduit comprises validating a condition for exclusion of the advertisement asset from the delivery queue, wherein the condition can include an operational condition of the first media conduit or a condition of the advertisement asset.

5. The method of claim 1, wherein determining, via at least the computing system, if the advertisement asset associated with the promotional campaign is excluded from the delivery queue associated with a first media conduit comprises ranking a group of advertisement assets including the advertisement asset based at least on respective advertisement spend for each of the group of advertisement assets, and
based on the ranking, identifying a second group of advertisement assets that fits open inventory associated with the delivery queue, and
determining if the advertisement asset is included in the second group of advertisement assets.

6. The method of claim 1, wherein the advertisement asset comprises a television spot, and wherein the first media conduit comprises an intended television network, and further wherein the second media conduit comprises an alternative television network.

7. The method of claim 1, wherein the advertisement asset comprises a television spot, and wherein the first media conduit comprises a television network, and further wherein the second media conduit comprises a web-based platform.

8. The method of claim 1, wherein the advertisement asset comprises a television spot, and wherein the first media conduit comprises a television network, and further wherein the second media conduit comprises a radio station.

9. At least one computer-readable non-transitory storage medium encoded with computer-accessible instructions that, in response to execution, cause at least one processor to perform advertisement management operations comprising:
accessing campaign information indicative of a promotional campaign directed to a first audience via a first media conduit;
determining if an advertisement asset associated with the promotional campaign is excluded from a first delivery queue associated with the first media conduit;
identifying a second media conduit based at least on the campaign information in response to ascertaining that the advertisement asset is excluded from the first delivery queue, the second media conduit is configured to convey content to a second audience satisfactorily similar to the first audience;
determining if open inventory is available for delivery of the advertisement asset via the second media conduit; and
configuring the advertisement asset in a second delivery queue associated with the second media conduit in response to ascertaining that the open inventory is available.

10. The at least one computer-readable non-transitory storage medium of claim 9, wherein the advertisement management operations further comprise delivering the advertisement asset via the second media conduit.

11. The at least one computer-readable non-transitory storage medium of claim 9, wherein determining if the advertisement asset associated with the promotional campaign is excluded from the delivery queue associated with a first media conduit comprises assigning a priority for allocation within the delivery queue, wherein the priority is determined according to a revenue provided by delivering the advertisement asset via the first media conduit, and
excluding the advertisement media asset from the delivery queue in response to the priority being below a predetermined threshold.

12. The at least one computer-readable non-transitory storage medium of claim 9, wherein determining if the advertisement asset associated with the promotional campaign is excluded from the delivery queue associated with a first media conduit comprises validating a condition for exclusion of the advertisement asset from the delivery queue, wherein the condition can include an operational condition of the first media conduit or a condition of the advertisement asset.

13. The at least one computer-readable non-transitory storage medium of claim 9, wherein determining if the advertisement asset associated with the promotional campaign is excluded from the delivery queue associated with a first media conduit comprises ranking a group of advertisement assets including the advertisement asset based at least on respective advertisement spend for each of the group of advertisement assets, and
based on the ranking, identifying a second group of advertisement assets that fits open inventory associated with the delivery queue, and
determining if the advertisement asset is included in the second group of advertisement assets.

14. A computing system for advertisement management, comprising:
at least one memory device having encoded thereon instructions; and
at least one processor functionally coupled to the at least one memory device and configured, by the instructions,
to access campaign information indicative of a promotional campaign directed to a first audience via a first media conduit;
to determine if an advertisement asset associated with the promotional campaign is excluded from a first delivery queue associated with the first media conduit;
to identify a second media conduit based at least on the campaign information in response to ascertaining that the advertisement asset is excluded from the first delivery queue, the second media conduit is configured to convey content to a second audience satisfactorily similar to the first audience;
to determine if open inventory is available for delivery of the advertisement asset via the second media conduit; and
to configure the advertisement asset in a second delivery queue associated with the second media conduit in response to ascertaining that the open inventory is available.

15. The computing system of claim 14, wherein the at least one processor is further configured, by the instructions, to deliver the advertisement asset via the second media conduit.

16. The computing system of claim 14, wherein the at least one processor is further configured to assign a priority for allocation within the delivery queue, wherein the priority is determined according to a revenue provided by delivering the advertisement asset via the first media conduit, and
to exclude the advertisement media asset from the delivery queue in response to the priority being below a predetermined threshold.

17. The computing system of claim 14, wherein the at least one processor is further configured to validate a condition for exclusion of the advertisement asset from the delivery queue, wherein the condition can include an operational condition of the first media conduit or a condition of the advertisement asset.

18. The computing system of claim 14, wherein the at least one processor is further configured to rank a group of advertisement assets including the advertisement asset based at least on respective advertisement spend for each of the group of advertisement assets, and
to identify, based on the ranking, a second group of advertisement assets that fits open inventory associated with the delivery queue, and
to determine if the advertisement asset is included in the second group of advertisement assets.

19. The computing system of claim 14, wherein the advertisement asset comprises a television spot, and wherein the first media conduit comprises an intended television network, and further wherein the second media conduit comprises an alternative television network.

20. The computing system of claim 14, wherein the advertisement asset comprises a television spot, and wherein the first media conduit comprises a television network, and further wherein the second media conduit comprises a web-based platform.

21. The computing system of claim 14, wherein the advertisement asset comprises a television spot, and wherein the first media conduit comprises a television network, and further wherein the second media conduit comprises a radio station.
